(19) United States
(12) Patent Application Publication
(10) Pub. No.: US 2006/0262817 A1
(43) Pub. Date: Nov. 23, 2006

(54) Method for mounting a light emitting device on a circuit board

(75) Inventors: Shih-Yuan Yu, Miao Li County (TW); Po-Chuan Kang, Miao Li County (TW); Wei-Jen Chou, Miao Li County (TW)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Coretronic Corporation

(21) Appl. No.: 11/432,142

(22) Filed: May 11, 2006

(30) Foreign Application Priority Data
May 17, 2005 (TW) 094115902

(51) Int. Cl. H01S 3/13

(52) U.S. Cl. 372/31

(57) ABSTRACT

A method for mounting a light emitting device on a circuit board includes: preparing a circuit board formed with at least one pair of conductive pads; applying a conductive paste on the conductive pads; preparing at least one light emitting unit that includes a light emitting chip and a pair of conductive contacts connected electrically to the light emitting chip; attaching the light emitting unit to the circuit board in such a manner that the conductive contacts are connected to the conductive pads, respectively, through the conductive paste; forming the conductive paste on the conductive pads into solid solder joints bonded to the conductive pads and the conductive contacts; and combining the light emitting unit with a lens cap unit after forming the solid solder joints.

### CROSS-REFERENCE TO RELATED APPLICATION

This application claims priority of Taiwanese application no. 094115902, filed on May 17, 2005.

### BACKGROUND OF THE INVENTION

1. Field of the Invention

This invention relates to a light emitting device, more particularly to a method for mounting a light emitting device on a circuit board.

2. Description of the Related Art

Due to low power consumption and long service life, light emitting diodes (LEDs) have become popular for application to backlight sources of a display device. The conventional method for mounting light emitting device on a circuit board is as following. First, a light emitting chip combines with a lens cap to form the light emitting device. Then, the light emitting device is mounted on the circuit board using surface mount technology (SMT). The lens cap is normally made from a plastic material, such as polymethylmethacryate (PMMA, which has a thermal resistance temperature lower than 100° C.) and polycarbonate (PC, which has a thermal resistance temperature lower than 120° C.), which tend to deteriorate due to absorption of heat generated from a reflowing operation of a solder paste in 330° C. for 1.5 seconds for bonding leads of the light emitting device on the circuit board. As a consequence, optical properties of the lens cap are adversely affected.

FIGS. 1A to 1D illustrate consecutive steps of another conventional method for mounting a light emitting device 14 (see FIG. 1C) on a circuit board 11. The light emitting device 14 includes a pair of conductive leads 141, a light emitting chip 142 and a lens cap 143. The conventional method includes: preparing the circuit board 11 (see FIG. 1A) having a substrate 110 that is provided with a circuit (not shown) and a plurality of conductive contacts 112 coupled to the circuit, and a solder mask 111 formed on the substrate 110; applying a solder paste 12 on the conductive contacts 112 and a thermal conductive glue 13 on a portion of the solder mask 111 between the conductive contacts 112 (see FIG. 1B); putting the light emitting device 14 on the circuit board 11 using a auxiliary device 15; attaching the light emitting device 14 to the circuit board 11 (see FIG. 1C) in such a manner that the light emitting chip 142 of the light emitting device 14 is adhesively bonded to the solder mask 111 through the thermal conductive glue 13 and that the conductive leads 141 of the light emitting device 14 are connected to the solder paste 12, and then the solder paste 12 is melted by hot bar 16 (see FIG. 1C) so as to form solder joints bonded to the leads 141 and the conductive contacts 112; and solidifying the solder paste 12 and the thermal conductive glue 13 (see FIG. 1D).

The aforesaid method is relatively complicated and is not suitable for mass production. In addition, the cost of the thermal conductive glue 13 is expensive. Moreover, since high luminant LEDs normally generate a considerable amount of heat, and since the thermal conductive glue 13 has poorer thermal conductivity and electrical conductivity than that of the solder joint, the use of the thermal conductive glue 13 in the mounting of an LED on a circuit board can result in a reduction in heat dissipation of the LED, which, in turn, can result in a decrease in the reliability of the LED after using for a period of time.

### SUMMARY OF THE INVENTION

Therefore, the object of the present invention is to provide a method for mounting a light emitting device on a circuit board that is capable of overcoming the aforesaid drawback of the prior art.

According to one aspect of the present invention, a method for mounting a light emitting device on a circuit board includes: preparing a circuit board formed with at least one pair of conductive pads; applying a conductive paste on the conductive pads; preparing at least one light emitting unit that includes a light emitting chip and a pair of conductive contacts connected electrically to the light emitting chip; attaching the light emitting unit to the circuit board in such a manner that the conductive contacts are connected to the conductive pads, respectively, through the conductive paste; forming the conductive paste into solid solder joints bonded to the conductive pads and the conductive contacts; and combining the light emitting unit with a lens cap unit after forming the solid solder joints.

### BRIEF DESCRIPTION OF THE DRAWINGS

In drawings which illustrate an embodiment of the invention,

FIGS. 1A to 1D are fragmentary schematic sectional views to illustrate consecutive steps of a conventional method for mounting a light emitting device on a circuit board;

FIG. 2 is a flow chart illustrating consecutive steps of the preferred embodiment of a method for mounting a light emitting device on a circuit board according to this invention; and

FIGS. 3A to 3D are fragmentary schematic sectional views of the consecutive steps of the preferred embodiment.

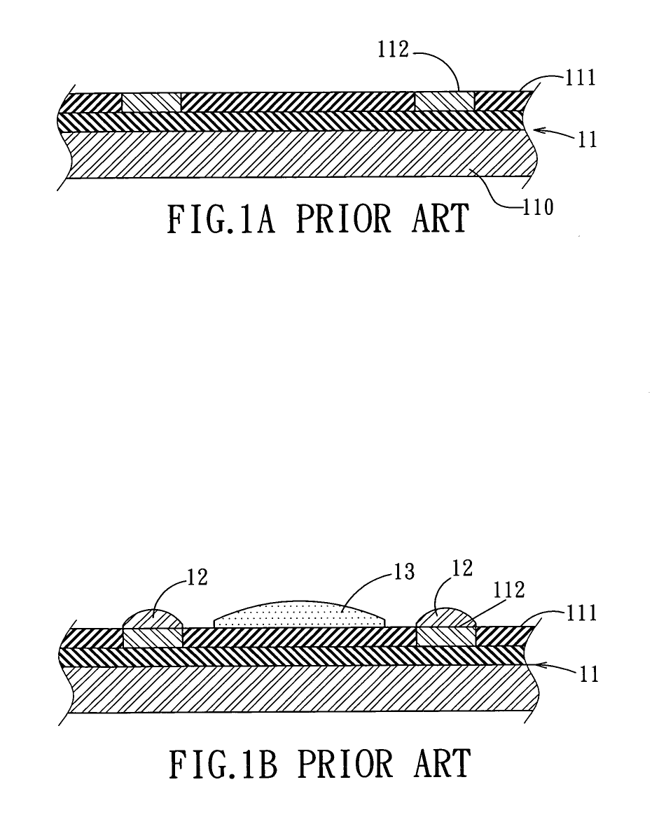

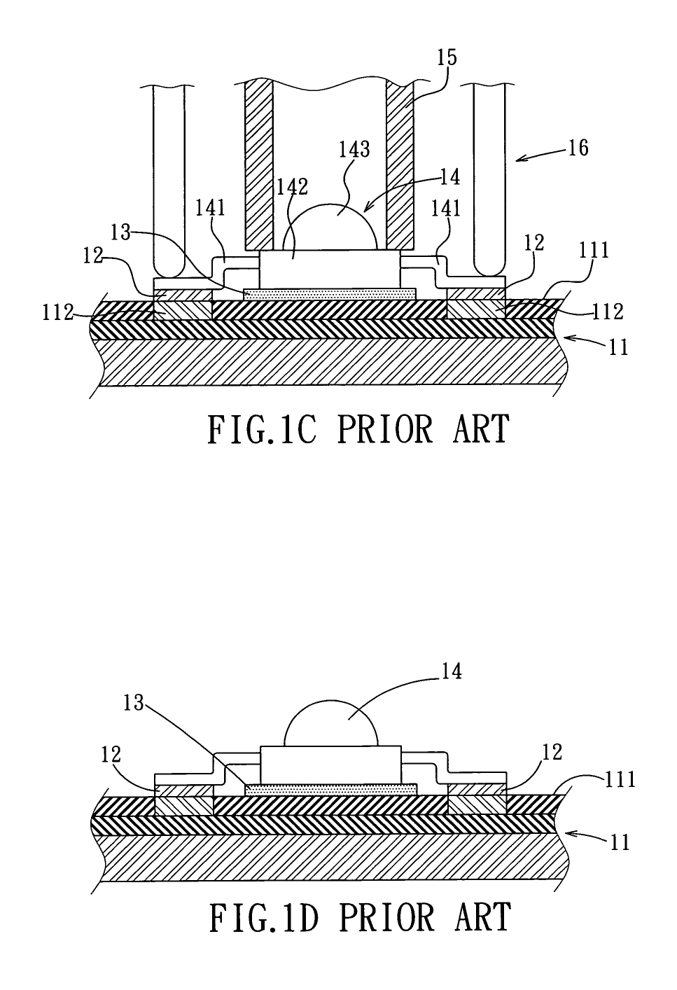

### DETAILED DESCRIPTION OF THE PREFERRED EMBODIMENT

This invention relates to a method of preparing an electronic assembly, such as a backlight module, including a circuit board and a light emitting device provided on the circuit board. The light emitting device has a plurality light emitting units and a lens cap unit combining the light emitting units.

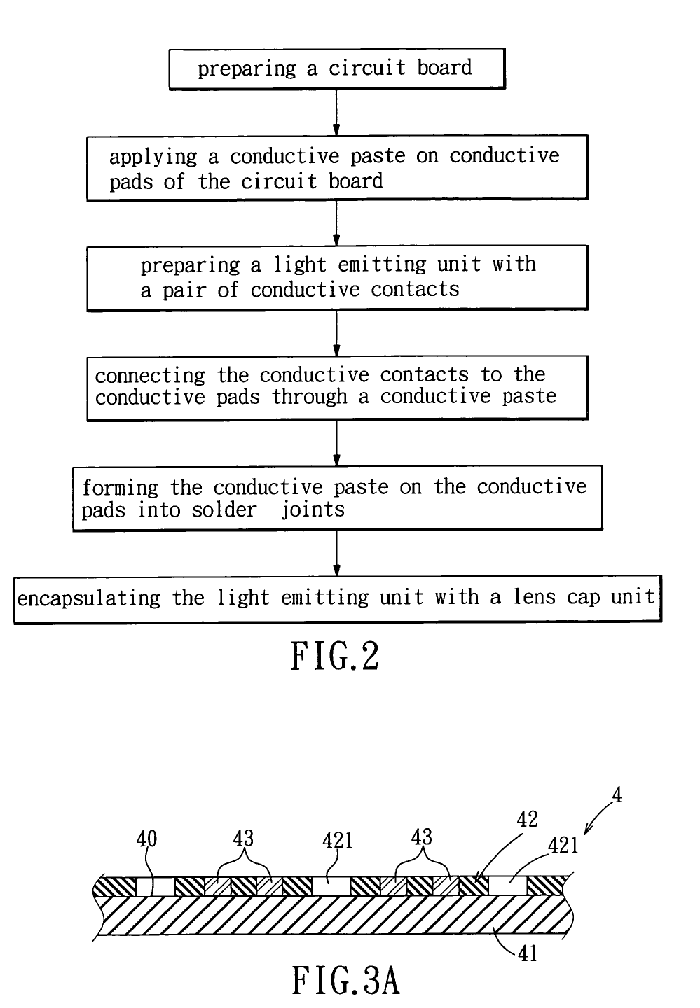

FIG. 2 illustrates consecutive steps of the preferred embodiment of the method for mounting the light emitting device on the circuit board according to this invention.

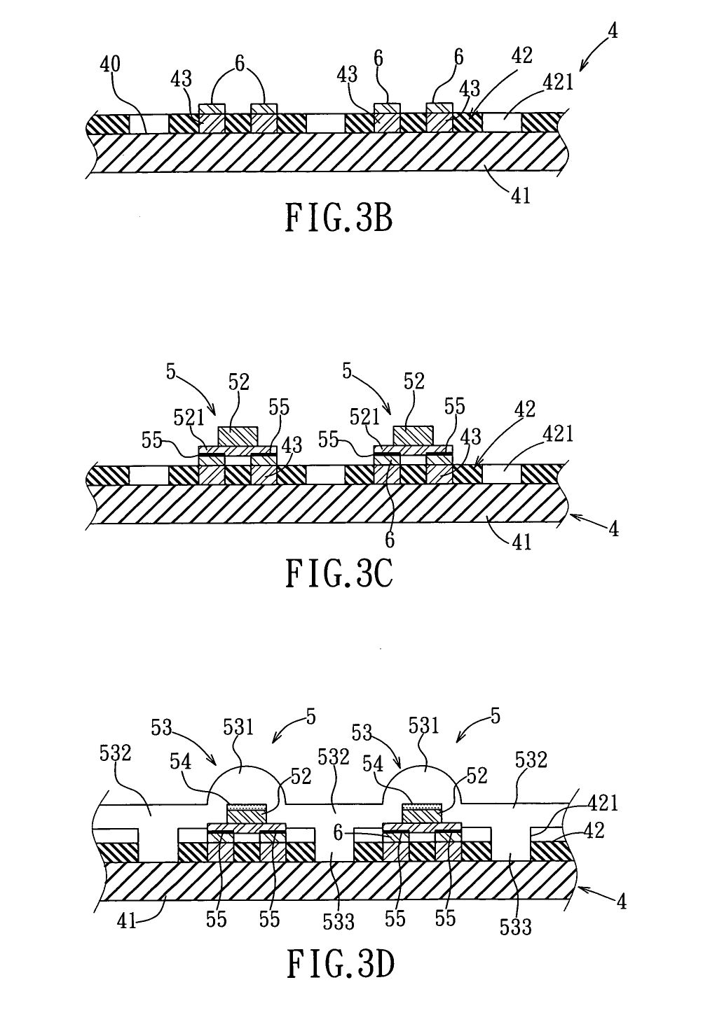

The method includes the steps of: preparing a circuit board 4 with a substrate 41 having a component-mounting surface 40, and formed with pairs of conductive pads 43 on the component-mounting surface 40 (see FIG. 3A) using techniques, such as sputtering techniques, vapor deposition techniques, and thermal diffusion deposition techniques, or using circuit printing techniques, each pair of the conductive pads 43 serving as electrodes in this embodiment; applying a conductive paste 6 on the conductive pads 43 (see FIG. 3B) using screen printing techniques; preparing a plurality of light emitting units 5, each of which includes a mounting base 521, a light emitting chip 52 formed on one side of the mounting base 521, and a pair of conductive contacts 55 formed on the other side of mounting base 521 (see FIG. 3C) and connected electrically to the light emitting chip 52; attaching the light emitting units 5 to the circuit board 4 (see FIG. 3C) in such a manner that the conductive contacts 55 of each of the light emitting units 5 are connected to the respective conductive pads 43 through the conductive paste 6; forming the conductive paste 6 on the conductive pads 43 into solid solder joints bonded to the conductive pads 43 and the conductive contacts 55; and combining the light emitting units 5 with a lens cap unit 53 (see FIG. 3D) so as to form the light emitting device on the circuit board 4 after forming the solid solder joints. Note that the conductive pastes 6 are subjected to a reflow process (i.e., a melting process, followed by a cooling process to solidify the solder melt.

Preferably, a solder-melting aiding agent (not shown) is applied to the solder paste 6 for facilitating melting of the solder paste 6 and for preventing oxidation of the solder paste 6 when forming into the solder joints and for enhancing heat conduction of the solder joints.

In this embodiment, the lens cap unit 53 is adhesively bonded to the light emitting chip 52 of each of the light emitting units 5 through an adhesive 54 which has a refractive index similar to that of the lens cap unit 53 and which is applied to the light emitting chip 52 prior to attachment of the lens cap unit 53 to the light emitting chip 52. The adhesive 54 is subsequently solidified by heating using a UV light or infrared ray. Note that after assembly of the light emitting units 5 and the circuit board 4, the assembly is subjected to electrical and optical tests, such as luminance and directivity, prior to the solidification of the adhesive 54.

The component-mounting surface 40 of the circuit board 4 is formed with an insulative positioning layer 42 that is formed with a plurality of alignment holes 421 (see FIG. 3A). As shown in FIG. 3D, the lens cap unit 53 includes a plurality of dome parts 531 that respectively combine the light emitting chips 52 of the light emitting units 5 and that are arranged into an array, a connecting part 532 extending laterally from and interconnecting the dome parts 531, and a plurality of alignment protrusions 533 that extend from the connecting part 532 into the alignment holes 421 in the positioning layer 42, respectively, so as to permit accurate alignment of the dome parts 531 with the light emitting chips 52 along a predetermined direction. The dome parts 531, the connecting part 532, and the alignments protrusions 532 are integrally formed into a single piece. Each of the dome parts 531 is semi-spherical in shape.

Preferably, each light emitting unit 5 can be formed with second alignment holes (not shown), while the lens cap unit 53 can be formed with second alignment protrusions (not shown) that extend into the second alignment holes for enhancing alignment of each dome part 531 with the respective light emitting chip 52.

The lens cap unit 53 is assembled to the light emitting units 5 using the adhesive 54 after formation of the solder joints, thereby avoiding the lens cap unit 53 from being subjected to a high temperature situation during the reflowing process as encountered in the prior art.

In addition, by using the lens cap unit 53, which can include a plurality of dome parts 531 in a single piece, and by mounting a plurality of the light emitting units 5 on the circuit board 4 in the method of this invention, the light emitting units 5 can be simultaneously combined by the dome parts 531 of the lens cap unit 53, which results in a significantly reduction in the manufacturing costs and production time as compared to the conventional method. Moreover, the thermal conductive glue 13 used in the aforesaid conventional method is dispensed with, thereby eliminating the aforesaid drawbacks attributed to the thermal conductive glue 13.

With the invention thus explained, it is apparent that various modifications and variations can be made without departing from the spirit of the present invention.

What is claimed is:

1. A method for mounting a light emitting device on a circuit board, comprising:
preparing a circuit board having a component-mounting surface, and formed with at least one pair of conductive pads on the component-mounting surface;
applying a conductive paste on the conductive pads;
preparing at least one light emitting unit that includes a light emitting chip and a pair of conductive contacts connected electrically to the light emitting chip;
attaching the light emitting unit to the circuit board in such a manner that the conductive contacts are connected to the conductive pads, respectively, through the conductive paste;
forming the conductive paste on the conductive pads into solid solder joints bonded to the conductive pads and the conductive contacts; and
combining the light emitting unit with a lens cap unit so as to form the light emitting device on the circuit board after forming the solid solder joints.

2. The method of claim 1, wherein the lens cap unit is adhesively bonded to the light emitting chip through an adhesive which is applied to the light emitting chip prior to combine the light emitting unit with the lens cap unit.

3. The method of claim 2, wherein the component-mounting surface of the circuit board is formed with an insulative positioning layer that is formed with a plurality of alignment holes, the lens cap unit including at least one dome part that combines the light emitting unit, a connecting part that extends laterally from the dome part, and a plurality of alignment protrusions that extend from the connecting part into the alignment holes in the positioning layer, respectively, so as to permit accurate alignment of the dome part with the light emitting chip along a predetermined direction.

4. An electronic assembly comprising:
a circuit board with a component-mounting surface; and
a light emitting device including
a plurality of light emitting units that are spaced apart from each other and that are mounted on said component-mounting surface of said circuit board, and
a lens cap unit including a plurality of spaced apart dome parts, and a connecting part that interconnects said dome parts, each of said dome parts combining a respective one of said light emitting units.

5. The electronic assembly of claim 4, wherein each of said dome parts is adhesively bonded to the respective one of said light emitting units.

6. The electronic assembly of claim 4, wherein said component-mounting surface of said circuit board is formed with an insulative positioning layer that is formed with a plurality of alignment holes, said lens cap unit further including a plurality of alignment protrusions that extend from said connecting part into said alignment holes in said positioning layer, respectively, so as to permit accurate alignment of each of said dome parts with the respective one of said light emitting units along a predetermined direction.

7. A lens cap unit, comprising:
a plurality of spaced apart dome parts, each of which is adapted to combine a respective one of light emitting units, said dome parts being arranged into an array; and
a connecting part interconnecting the dome parts.

8. The lens cap unit of claim 7, wherein said dome parts and said connecting part are integrally formed into a single piece.

9. The lens cap unit of claim 7, further comprising a plurality of alignment protrusions that extend from said connecting part, each of said alignment protrusions being adapted to be extended into a respective one of alignment holes in a positioning layer on the circuit board.

10. The lens cap unit of claim 7, wherein each of said dome parts is semi-spherical in shape.
